(19) United States
(12) Patent Application Publication
(10) Pub. No.: US 2018/0357984 A1
(43) Pub. Date: Dec. 13, 2018

(54) SYSTEM, METHOD, AND APPARATUS FOR DISPLAYING DATA

(71) Applicant: Alibaba Group Holding Limited, George Town (KY)

(72) Inventor: Jie Xia, Hangzhou (CN)

(21) Appl. No.: 16/002,940

(22) Filed: Jun. 7, 2018

(30) Foreign Application Priority Data
Jun. 12, 2017 (CN) 201710438341.0

(51) Int. Cl. G09G 5/32; G06F 3/01; G09G 5/00; G06K 9/00

(52) U.S. Cl. CPC G09G 5/32; G06F 3/017; G09G 2360/144; G06K 9/00389; G09G 5/003

(57) ABSTRACT

A method for displaying data, including: identifying the data to be displayed; and displaying the data in a first region of a display screen, wherein the first region is determined based at least in part on a portion of the display screen that is being obscured.

### CROSS REFERENCE TO OTHER APPLICATIONS

This application claims priority to People's Republic of China Patent Application No. 201710438341.0 entitled DATA DISPLAY METHOD, MEANS, AND SYSTEM, filed Jun. 12, 2017 which is incorporated herein by reference for all purposes.

### FIELD OF THE INVENTION

The present invention generally relates to the field of data processing technology and more particularly, to a system, method and apparatus for displaying data.

### BACKGROUND OF THE INVENTION

With the rapid and vast development of the Internet technology along with the similar trend of the terminal device technology, smart terminal devices such as mobile phones, tablet computers, notebook computers, wearable devices, Internet of Things (IoT) devices, in-vehicle devices, desktop computers, and the like, have been deployed in a broad variety of applications and aspects of people's life and work. Taking mobile phones for example, with the availability of various services and applications (APPs), rather than functioning merely as a communication tool, mobile phones have evolved into a portal device providing users access to services and functionalities such as E-mails, GPS navigation, mobile payment, picture-taking, and so on. As a result, mobile phones have become a necessity to people's everyday life. However, the more functionalities or services a mobile phone provides to a user, the more frequently and the more time the user tends to spend operating the mobile phone. Naturally, the user is experiencing a higher risk of his or her personal or private or sensitive data being misappropriated due to the use of mobile phones. For example, a user sometimes receives a text message or a WeChat message while in a public space such as a subway, or a mall. When the user checks the received message in a crowd at a public space the same way as at a personal space (e.g., at home or at office), sensitive or personal data is prone to be viewed by strangers nearby who can look over the shoulder, resulting in breaches of sensitive or personal data.

At present, the conventional data display on mobile phones oftentimes notifies a user with an audible or visual alert of each arrival of new messages. The user is required to manually unlock the screen (if in a locked state), and manually check for the new messages. Sometimes, certain types of messages are scroll displayed at a notification bar (e.g., a top portion of the display screen), the texts of the messages being displayed in a relatively small font size. As displayed for a short period of time, the message tends to disappear before the user is able to read it. In other scenarios where the message is known to be of particular importance, the user has to unlock the locked phone screen and gain normal access to the corresponding messaging APP (SMS APP, E-mail APP, etc.) in order to access the full content of the message. After the user performs the unlocking of the home screen of the mobile phone, as described above, the risk of a stranger being able to misappropriate the data displayed on the user's phone screen runs high when the user is at a public space.

Therefore, there exists a need for providing a secure and private way of displaying data on mobile devices.

### BRIEF DESCRIPTION OF THE DRAWINGS

Various embodiments of the invention are disclosed in the following detailed description and the accompanying drawings.

The drawings described here are intended to further the understanding of the present invention and form a part of the present application. The illustrative embodiments of the present invention and the descriptions thereof are intended to explain the present invention and do not constitute inappropriate limitation of the present invention. Among the drawings:

FIG. 1A is a schematic diagram illustrating a notification of an incoming call at a display screen on a mobile device, in accordance with prior art.

FIG. 1B is a schematic diagram illustrating a display of an SMS text message at a display screen on a mobile device, in accordance with prior art.

FIG. 1C is a schematic diagram illustrating a notification of new or unread messages at icons of the corresponding APPs at a display screen on a mobile device, in accordance with prior art.

FIG. 2 is a functional block diagram illustrating an example system for displaying data, in accordance with one or more embodiments of the present disclosure.

FIG. 3 is a flow chart illustrating an example process for displaying data, in accordance with one or more embodiments of the present disclosure.

FIG. 4A is a schematic diagram illustrating an example scenario in which a book is used to obscure a portion of a display screen of a mobile phone, in accordance with one or more embodiments of the present disclosure.

FIG. 4B is a schematic diagram illustrating another example scenario in which a user's hand is used to obscure a portion of a display screen of a mobile phone, in accordance with one or more embodiments of the present disclosure.

FIG. 4C is a schematic diagram illustrating yet another example scenario in which a user's hand gesture (e.g., shape of user's hand gesture) is used to determine a first region of a display screen of a mobile phone, in accordance with one or more embodiments of the present disclosure.

FIG. 4D is a schematic diagram illustrating still yet another example scenario in which a user's hand is used to provide further privacy guards for a target region of a display screen of a mobile phone, in accordance with one or more embodiments of the present disclosure.

FIG. 5 is a schematic diagram of an example system for displaying data, in accordance with one or more embodiments of the present disclosure.

FIG. 6 is a flow chart illustrating an example process for displaying data, in accordance with one or more embodiments of the present disclosure.

FIG. 7 is a schematic diagram illustrating an example system for displaying data, in accordance with one or more embodiments of the present disclosure.

FIG. 8 is a functional diagram illustrating an embodiment of a programmed computer system for displaying data, in accordance with one or more embodiments of the present disclosure.

FIG. 9 is a flow chart illustrating an example process for displaying data, in accordance with one or more embodiments of the present disclosure.

FIG. 10 is a flow chart illustrating another example process for displaying data, in accordance with one or more embodiments of the present disclosure.

FIG. 11 is a flow chart illustrating yet another example process for displaying data, in accordance with one or more embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

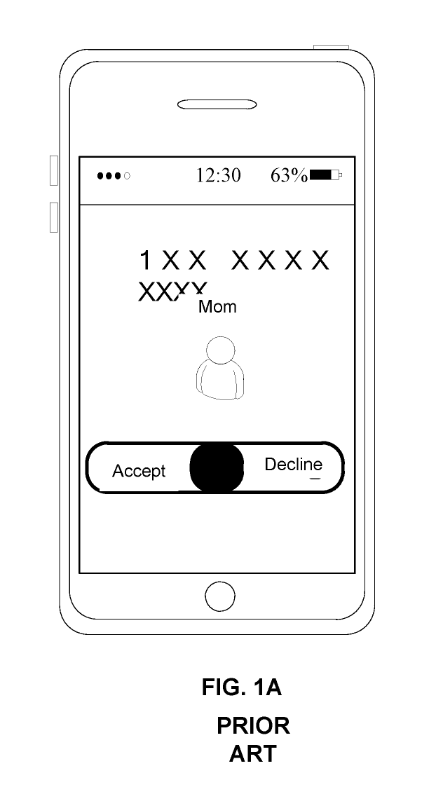

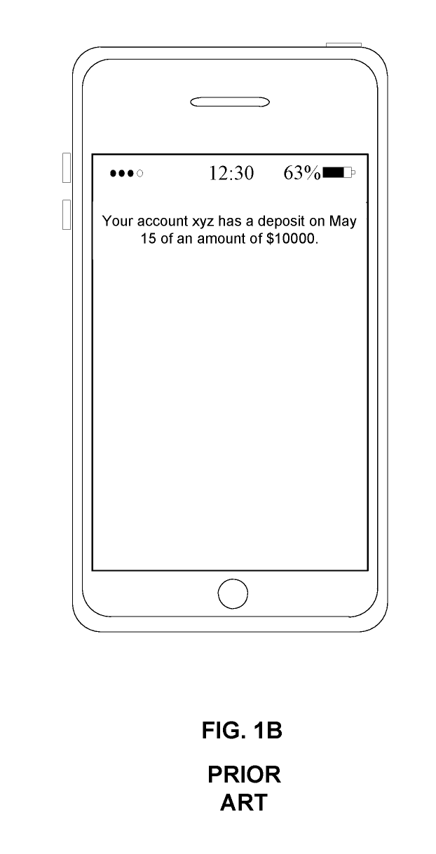

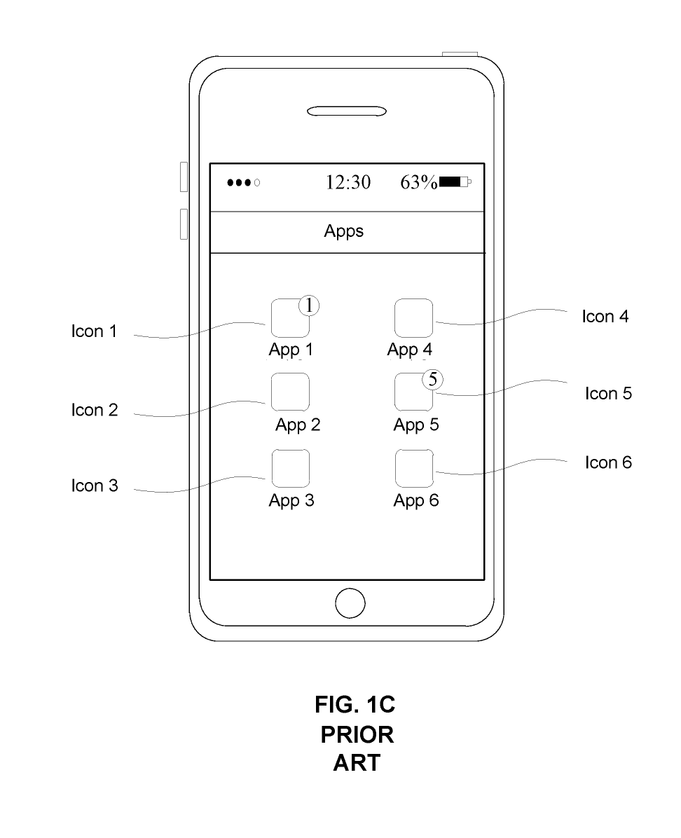

FIG. 1A illustrates a schematic diagram of a notification of an incoming call displayed at a display screen of a mobile phone in accordance with prior art. As shown herein, with the conventional data display techniques, information of such an incoming call is displayed at the display screen of the mobile phone upon receiving an incoming call. As shown herein, regardless of the display screen being in a screen lock state, information such as the name of the caller (e.g., the contact name associated with the phone number of the caller in the contact list) is displayed at the central region of the display screen in a prominent manner. Under the circumstances where the user is at a party or in a meeting, if the mobile phone is placed face up with the screen locked, people in proximity of the user are able to see who is calling since the caller information is presented in such a prominent manner. Sometimes, if the user does not wish for the information about that particular caller who is calling to be known to other people, the present display of an incoming call notification tends to breach a user's privacy.

FIG. 1B illustrates a schematic diagram of a display of an SMS text message at a display screen of a mobile phone in accordance with prior art. In this example, the user has configured the feature of notification upon receiving short text messages as turned on. As such, the content of an incoming SMS message is displayed in a notification bar configured in the topmost region of the display screen. Typically, the content of a message scrolls by in the notification bar, in a relatively small font size. As shown herein, the user receives a message from his or her bank indicating that there has been a deposit of a particularly large amount into the account. The conventional techniques, without differentiation, allow the notification to pop up at the notification bar and to be scroll displayed even when the user is in a crowd and possibly attract unwanted attention with this information.

FIG. 1C illustrates a schematic diagram of a display of notification of new or unread messages at icons of the corresponding APPs in accordance with prior art. As shown herein, the display screen of the mobile phone is in a screen-unlocked state. A multitude of icons (icon 1, icon 2, icon 3, icon 4, icon 5, and icon 6) of respective APPs (APP1, APP2, APP3, APP4, APP5, and APP6) are shown at the display screen of the mobile device. When APP 1 receives new messages or data, icon 1 is rendered to display the number of unread messages at, for example, the upper right corner thereof. As such, the user is notified of the status that there are new messages associated with APP 1. If the user would like to check for the new messages, the user needs to click upon the icon (icon 1) corresponding to APP1 to access the content of the new messages. Again, taking the above-described examples of the user operating a mobile device in a public space, the content of the new messages associated with APP1 is again exposed to the risk of being misappropriated by strangers in proximity of the user.

As made apparent in FIGS. 1A-1C, with the conventional data display techniques, either only a notification of new messages or data is displayed to the user without showing the particular content of the new messages or data, resulting in the user not being able to check the content of messages in a timely manner and ending up missing or delaying in responding to the new message in real time, or, if the content of the new messages is displayed via a default setting (e.g., scroll display at a notification bar), the risk of such content being misappropriated by other people in a public space runs high, and can result in breaches of sensitive or personal information. In particular, given the trend that the size of a display screen of a mobile device is becoming larger and larger, accessing data at a mobile device in a public space incurs even higher risk of the user privacy being breached.

A technique for displaying data with enhanced privacy guards at a user interface of a terminal device is described herein. According to various embodiments of the present disclosure, prior to displaying sensitive or personal data at a mobile device, a user-designated region at the display screen of the mobile device is determined such that the sensitive or personal data is displayed in the designated region accordingly. For example, a user can utilize an object, such as his or her hand, a book, a purse, or the like to obscure a portion of the display screen in a manner that the portion of the display screen that is still visible to the user is determined as the designated region for displaying sensitive or personal data. As the object covers or hovers at the display screen, the eye sight of others in proximity of the display screen is blocked from viewing the designated region, therefore prying eyes are prevented from reading sensitive or personal information displayed at the mobile device, and the user's privacy is protected while accessing the sensitive or personal data in a public space.

Upon determining an obscured region of the display screen, the data is displayed in a display region determined based on the obscured region. In some embodiments, the display region of the display screen is defined by the user either in a pre-determined manner, or in real time in a manner suitable under the circumstances or contexts of the user. In some embodiments, the definition of the display region is modified or canceled at any time based on various contexts or circumstances. With the flexible and context-aware designation of a private display region at the display screen, heightened privacy is provided to the user during the viewing of personal or sensitive data displayed in such designated region.

According to various embodiments of the present disclosure, data displaying can be applied to any scenarios where data or information is to be displayed or presented to a user of a terminal device. Such a terminal device includes, for example, a mobile phone, a smart phone, a tablet computer, a notebook computer, a wearable device, an Internet of Things (IoT) device, an in-vehicle device, a desktop computer, a mobile Internet device (MID), and the like. Corresponding operating systems on these above-described terminal devices include, for example, iOS, Android, Sybian, Windows CE, Windows, and the like. Data for displaying can include data of a system process, or data provided of an application. For example, in addition to content of documents or programs, such data include incoming phone messages, short text messages (SMS) messages, E-mail messages, multi-media messages (MMS) messages, text messaging APP messages, promotional messages, and messages from other APPs. In particular, messages include, for example, messages from applications such as Facebook Messenger™, Snapchat™, WeChat™, QQ™, news alerts, stock alerts, IoT network messages, as well as the notifications thereof. Applications can include, for example, instant messaging software programs, E-mail programs, mobile payment programs, mobile banking programs, or any application or processes a user operates to access information.

In some embodiments, the data to be displayed is transmitted to the user without the user's request (e.g., SMS messages or E-mail messages). In some embodiments, the data to be displayed is transmitted to the mobile device upon a user's request. For example, a privacy sensitive scenario can be that, the user is viewing or editing proprietary documents on the mobile device that has established a virtual desktop connection with a company's intranet. Alternatively, the user is viewing or editing proprietary documents that have been previously downloaded on the mobile device.

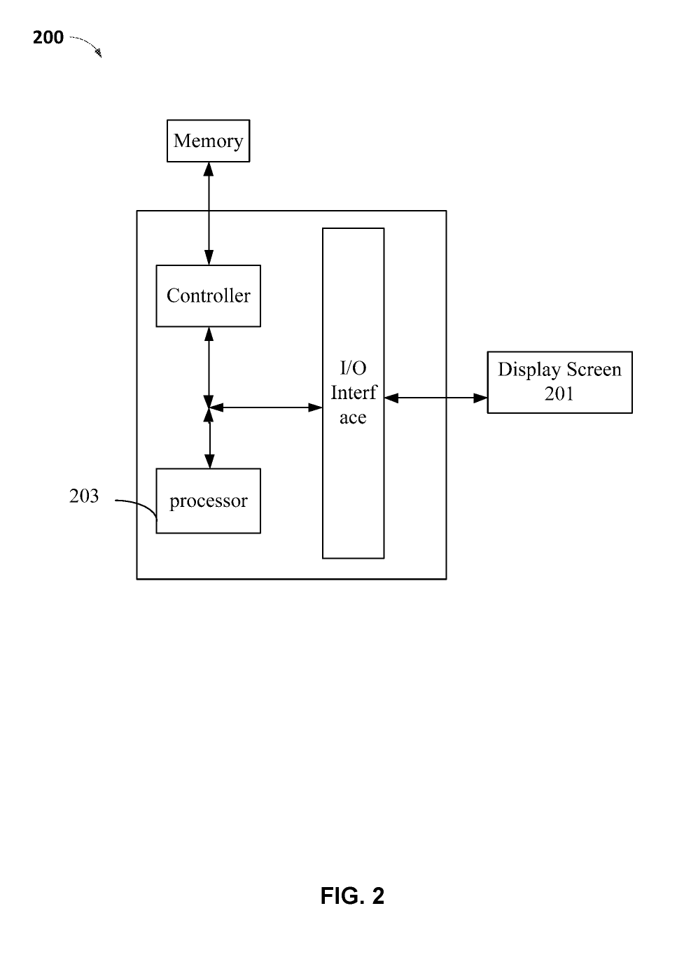

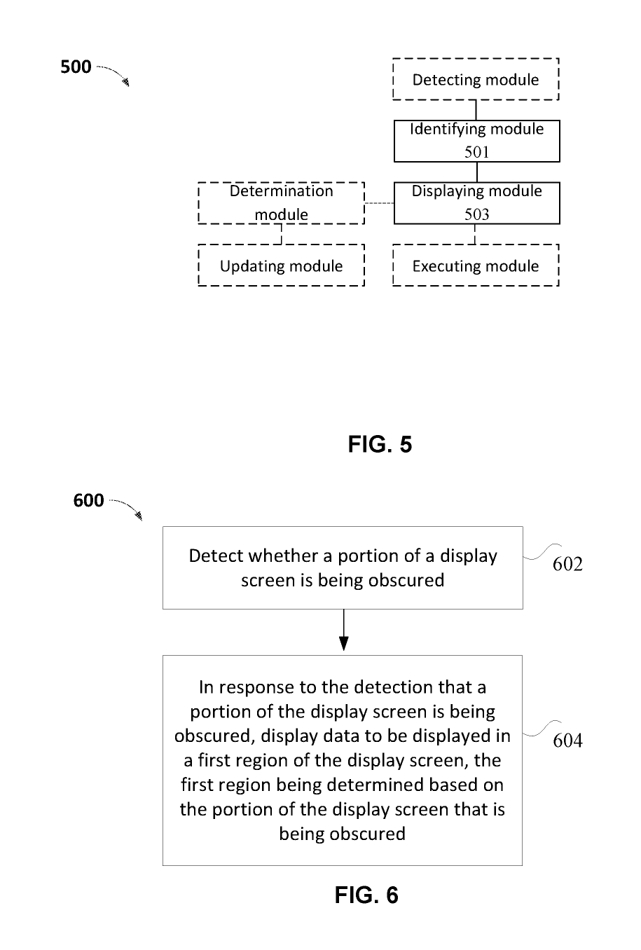

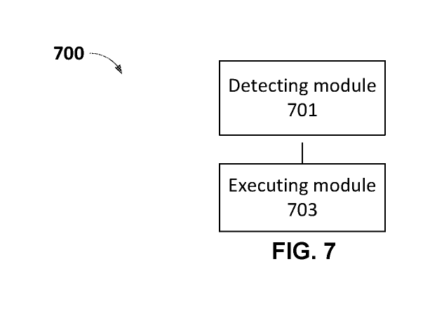

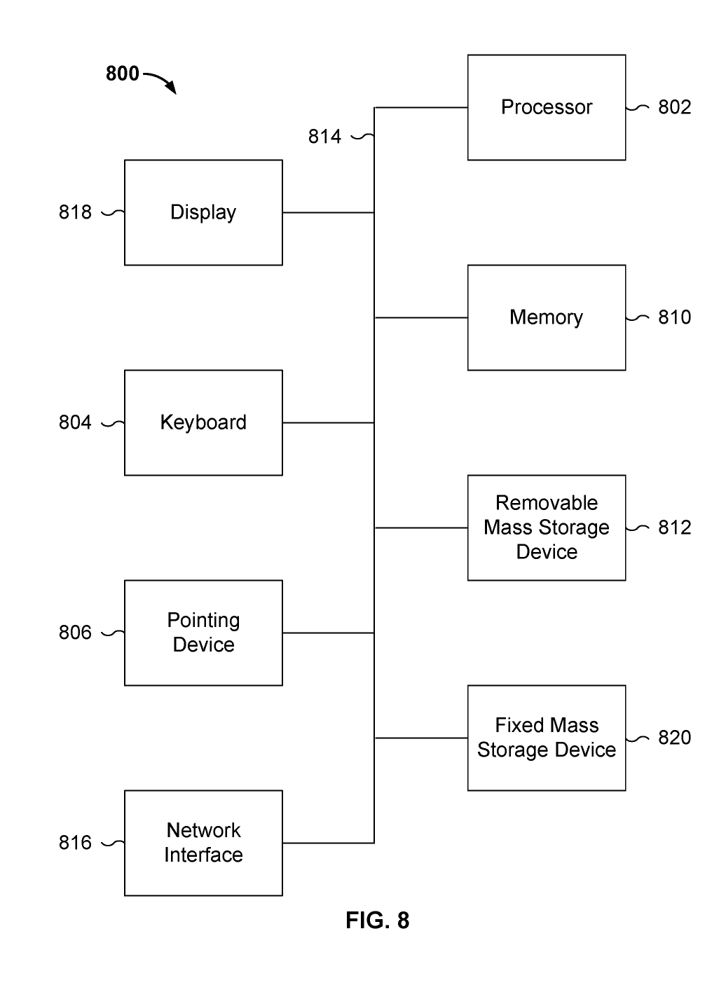

FIG. 2 illustrates a functional block diagram of an example system for displaying data in accordance with an embodiment of the present disclosure. In this example, system 200 includes a display screen 201, and a processor 203. System 200 can be implemented by, for example, system 500 of FIG. 5, system 700 of FIG. 7, or computing system 800 of FIG. 8.

Display screen 201 is configured to, subsequent to system 200 having identified data to be displayed, detect whether a portion of the display screen is being obscured. In some embodiments, display screen 201 is configured with various mechanisms (e.g., sensors, etc.) to detect an object in proximity thereof, and the detected data is analyzed by a controller or a processor to determine the portion of the display screen that corresponds to the area being obscured by the object.

Processor 203 is configured to display the data identified for displaying in a first region of the display screen in response to detecting that a portion of the display screen is being obscured. The first region is determined based on the portion of the display screen that is being obscured. In some embodiments, the first region of the display screen corresponds to an area of the display screen that is not being obscured. In some embodiments, the first region of the display screen corresponds to an area of the display screen that detects a change in the brightness level and/or intensity level of ambient light due to the fact that a portion of the display screen is being obscured.

In various embodiments, display screen 201 can be implemented using any suitable technologies including resistive, capacitive, infrared, surface acoustic wave, near field imaging, electromagnetic, and the like to detect whether a portion thereof is being obscured. In some embodiments, display screen 201 is configured as a touch screen, e.g., the touch screen of a mobile device. For simplicity of illustration, four types of display screen are described in the following. It should also be understood that display screen 201 and processor 203 can be either implemented at the same device (e.g., a smart phone, a tablet computer, a notebook computer, a wearable device, etc.), or at separate devices (desktop computer's monitor display and case including the processor, memory, bus, etc.)

In resistive technologies, display screen 201 is coated with layers that are electrically conductive and resistive. When display screen 201 is touched or pressed, for example, the layers come into contact thereby rendering a change in impedance, which is used to determine the position of the point of contact. As such, the regions obscured via touch or contact with the display screen can be determined based on the change in the distribution of impedance; and a first region can be in turn determined based on the obscured regions.

In capacitive technologies, display screen 201 is coated with materials that stores electrical charge. When display screen 201 is touched or pressed, an amount of charge is drawn to the point of contact thereby rendering a change in capacitance (charge information). As such, the regions obscured via touch or contact with the display screen can be determined based on the change in the capacitance; and a first region can be in turn determined based on the obscured regions.

In surface acoustic sound wave technologies, ultrasonic waves are transmitted both horizontally and vertically over display screen 201. When display screen 201 is touched or pressed, acoustic energy is absorbed at the point of contact thereby rendering a change in the level of acoustic energy. As such, the regions obscured via touch or contact with the display screen can be determined based on the change in the acoustic energy level; and a first region can be in turn determined based on the obscured regions.

In infrared technologies, light beams are transmitted both horizontally and vertically over display screen 201. When display screen 201 is touched or pressed, emanating light beam are interrupted at the point of contact. As such, the regions obscured via touch or contact with the display screen can be determined based on the interruption of the light beam emanating from display screen 201; and a first region can be in turn determined based on the obscured regions.

In some other implementations, display screen 201 is configured with sensors that are capable of detecting a touching event or a spatial event in proximity thereof. For example, piezoelectric sensors can be used to sense a touch event based on the change of pressure of the like. For another example, cameras can be used to detect user gestures both touching and not touching a display screen. As such, the regions obscured via touch or contact with the display screen can be determined based on the detected touch event or spatial event at display screen 201; and a first region can be in turn determined based on the obscured regions.

In some other implementations, the first region is designated by the user specifying an area on display screen 201 (e.g., by drawing with a finger, a stylus, or the like on display screen 201.) Various techniques can be used to designate the first region on display screen 201.

As designated by use's contact, gesture, or drawing, the first region is user defined and the manner display screen 201 is obscured can be determined based on particular contexts or circumstances. For example, the user can determine and adjust the position, the angle, or the like at which he or she is to place a hand over display screen 201. In some embodiments, the user may obscure a portion of display screen 201 with a hand gesture.

As used herein, the term “hand gesture” or “gesture” refers to a user's motion, conducted either by user's hand, a stylus, or any other object or device, that is indicative of a particular command or request. Gestures and their corresponding meanings can be application and/or context specific. Gestures include, for example, a hand cover (e.g., placing a hand to cover a display screen), a hand wave (e.g., a horizontal wave, or a vertical wave), a pinch, a shape (e.g., a circle drawn by a finger), and the like. Gestures can be determined by, for example, analyzing a motion direction, motion speed, motion length, motion's speed approaching a display screen, motion's speed away from a display screen, motions' distance from a display screen, coordinates of the objects generating motions, etc.

According to various embodiments of the present disclosure, upon identifying data to be displayed, the displaying of data at a user-designated region at the display screen of the mobile device realizes the protection of the displayed data in the designated area, resulting in enhanced protection of a user's privacy. As such, sensitive or personal data is less prone to be misappropriated at a mobile device.

In some embodiments, system 200 is invoked to display data in the first region when display screen 201 is in a screen unlock state. In some embodiments, system 200 is invoked to display data in the first region when display screen 201 is in a screen lock state. In the latter scenario, processor 203 is configured to obtain data to be displayed after display screen 201 determines that a portion thereof is being obscured. For example, it can be detected whether an object is placed above display screen 201.

Is some embodiments, the above-described object that renders a portion of the display screen obscured is a user's hand. In this case, the first region of the display screen is determined based on the user's hand gesture, which is conducted to obscure a portion of display screen 201.

In some embodiments where display screen 201 is implemented as a touch screen, the first region is designated by the user tracking his or her finger, a stylus or the like on display screen 201 to define the first region on display screen 201 for displaying data. Subsequently, the user can position his or her hand, or any suitable objects (e.g., a book, a purse, etc.) in proximity of the first region such that to further ensure the data displayed in the first region is not in the field of view of others nearby.

In some embodiments where a user's hand gesture is moving about on display screen 201, the first region determined based on the user's hand gesture is updated accordingly. For example, in the beginning, the user can designate the first region in the middle of display screen 201 using a hand gesture. Later, the user can slide the hand gesture further down towards the bottom portion of display screen 201 such that the first region is defined at a left bottom area or a right bottom area of display screen 201, where usually it is more difficult for others to be able to view or look over. In some embodiments, a prior designation of the first region can be performed using objects other than a hand gesture (e.g., a book, or user's finger tracking on a display screen, etc.), and a hand gesture is used to update the first region on the display screen to better suit the user's context or nearby situations.

In some embodiments, after the data to be displayed is presented to the user in the first region, if display screen 201 ceases to detect that a portion thereof is being obscured (e.g., by a user's hand gesture, by a book, etc.), the displayed data in the first region is removed from the first region. In some embodiments, the data already displayed in the first region can disappear from display screen 201. In some other embodiments, the data already displayed in the first region can be configured to be displayed at a region other than the first region of display screen 201. For example, the data already displayed in the first region can be displayed at a preset default region (e.g., a notification bar) of display screen 201. The former can be applied to scenarios where the user is done accessing sensitive or personal data on the mobile device at the public space. Therefore, the user no longer needs a portion of display screen 201 to be obscured, and there is no need to display the data any more. The latter can be applied to scenarios where the user has transitioned from a public space to a private space (e.g., getting off the subway and getting into the car, etc.). As such, in these embodiments, privacy guards are probably no longer needed in order for the user to access the sensitive or personal data on the mobile device. Therefore, such data can be displayed according to a default setting.

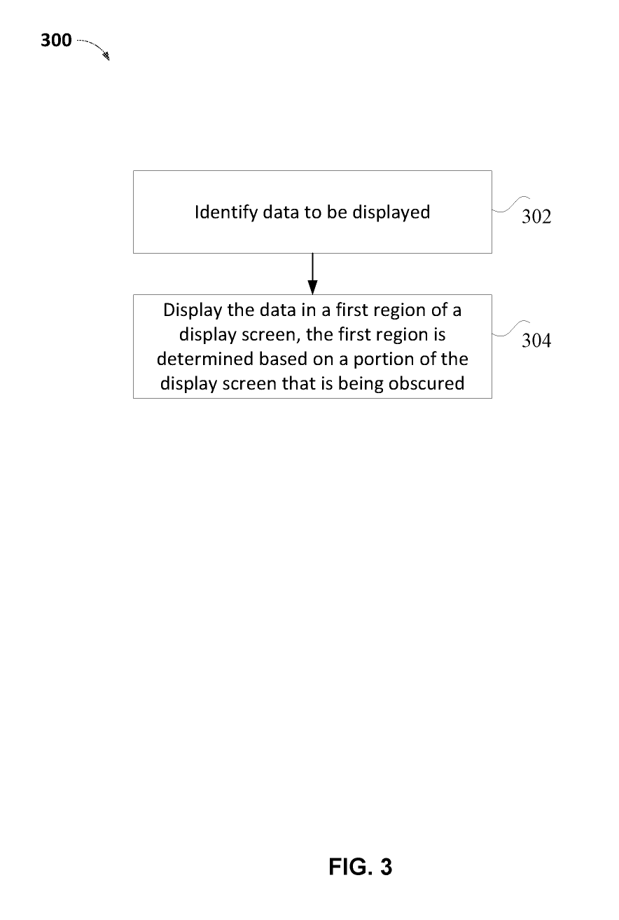

FIG. 3 illustrates a flow chart of an example process for displaying data in accordance with an embodiment of the present disclosure. Process 300 can be implemented at, for example, system 200 of FIG. 2, and system 800 of FIG. 8.

Process 300 starts at 302, where data to be displayed is identified.

In some embodiments, the data to be displayed is the data that needs to be displayed with privacy guards in a secure manner. In other words, the data to be displayed is to be displayed at a designated region of the display screen. In some embodiments, such data includes new messages or new information received at a mobile device. For example, such messages or information include incoming call notifications, content of short text messages, content of E-mails, content of WeChat messages, Content of QQ messages, content of news alerts, content of social media related messages, content related to mobile payments, content related to mobile banking, content of wearable device data, etc. Upon the receiving an above-described message, the content of such message is obtained as the data to be displayed. This way, upon the arrival, each new message is to be displayed with privacy guards in a secure region of the display screen.

In some other embodiments, the data to be displayed includes data that is pre-configured as sensitive or personal data. In this case, all the data designated as sensitive or personal is to be displayed with privacy guards in a secure manner; while data not designated as sensitive or personal is to be displayed normally, or according to a default setting for displaying data. For example, a user can pre-configure one or more particular contacts as personal contacts (personal data). When there is an incoming call from these particular one or more contacts, the incoming call notification will not be displayed upon receiving the call. Instead, the incoming call notification will be displayed according to the configurations for displaying sensitive or personal data as described above. For another example, the user can preconfigure data pertaining to a particular APP (e.g., mobile banking APP, AliPay, Virtual desktop, etc.) as sensitive data. When such a particular APP generates a notification to the user, the notification will not be displayed to the user. Instead, the notification will be displayed according to the configurations for displaying sensitive or personal data as described above.

In some embodiments, data to be displayed includes data that the user requests access to or receives at the mobile device. For example, the user may log into a virtual desktop environment in order to access proprietary documents on the mobile device. Here, the user can turn on a privacy guard for the WORD APP or the browser APP such that documents or files are displayed according to the configurations for displaying sensitive or personal data as described above.

In some embodiments, data to be displayed can also include any data including, for example, text, pictures, video, animation, and the like.

At 304, data to be displayed is displayed at the first region of a display screen, the first region being determined based on the portion of the display screen that is being obscured (e.g., by subtracting from the display screen the portion that is being obscured). In some embodiments, the first region corresponds to an area of the display screen that is not being obscured.

In particular, the first region of the display screen is a designated area configured to display data (e.g., sensitive data or personal data) in a secure manner, which provides for enhanced security to data being displayed in the designated area. A designated first region can be updated in real time according to how the display screen is obscured. For example, the size, shape, position, brightness level, and/or opacity level of the first region can be modified based on which portion of the display screen is detecting an obscured object. After data to be displayed is identified, the first region is configured to display the data to be displayed. In other words, data to be displayed is displayed in a protected region of the display screen.

In some embodiments, the first region is configured to display data when the display screen is in a screen lock state. In some other embodiments, the first region is configured to display data when the display screen is in a screen unlock state.

Again, by displaying data in the first region which is determined based on a portion of the display screen being obscured, data (e.g., sensitive data or personal data) can be displayed with enhanced privacy. Further, the first region is user designated, and can be updated in real time according to how the display screen is obscured. For example, the size, shape, position, brightness level, and/or opacity level of the first region can be modified based on which portion of the display screen is detecting an obscuring object. In some embodiments, a portion of the display screen is obscured by a user's hand gesture.

According to various embodiments of the present disclosure, upon identifying data to be displayed, the displaying of data at a user-designated region at the display screen of the mobile device realizes the protection of the displayed data in the designated area, resulting in enhanced guards of users' privacy. As such, sensitive or personal data is less prone to be misappropriated at a mobile device.

In some embodiments where the display screen is in a screen lock state, upon receiving data to be displayed, it is detected whether a portion of the display screen is being obscured by an object (e.g., an object is placed above the display screen). If it is detected that a portion of the display screen is being obscured by an object, data to be displayed is retrieved. Obscuring objects include any suitable objects that can be used to obscure a portion of the display screen. For example, an object can be a user's hand, a book, a purse, or the like.

In particular, regardless of whether the user's hand or another object is used to obscure a portion of the display screen, such an object positioned above the display screen renders a change in the brightness or intensity level of ambient light sensed at the display screen. Further, touches or contacts upon the display screen renders pressure detected on the display screen. Therefore, obscured regions from un-obscured regions are determined based on detecting changes in the brightness level or the intensity level of ambient light detected at the display screen, or changes in pressure detected at the display screen. For example, when the pressure sensed at the display screen is used, the areas sensing a change in pressure are determined as the obscured areas; while those areas not sensing a change in pressure are determined as the un-obscured areas. When the brightness level or intensity level of ambient light sensed at the surface of the display screen is used, the areas sensing a change (e.g., reduced amount) in the brightness level or intensity level of ambient light are determined as obscured areas; while those not sensing a change in the brightness level or the intensity level of ambient light are determined as the un-obscured areas.

In some embodiments, the display screen can be implemented as various types of touch screen including, for example, resistive panels, capacitive panels, acoustic wave panels, infrared panels, and the like. It should be understood that any suitable technologies for enabling detection of whether a portion of a display screen is obscured can be applied herein without limitation.

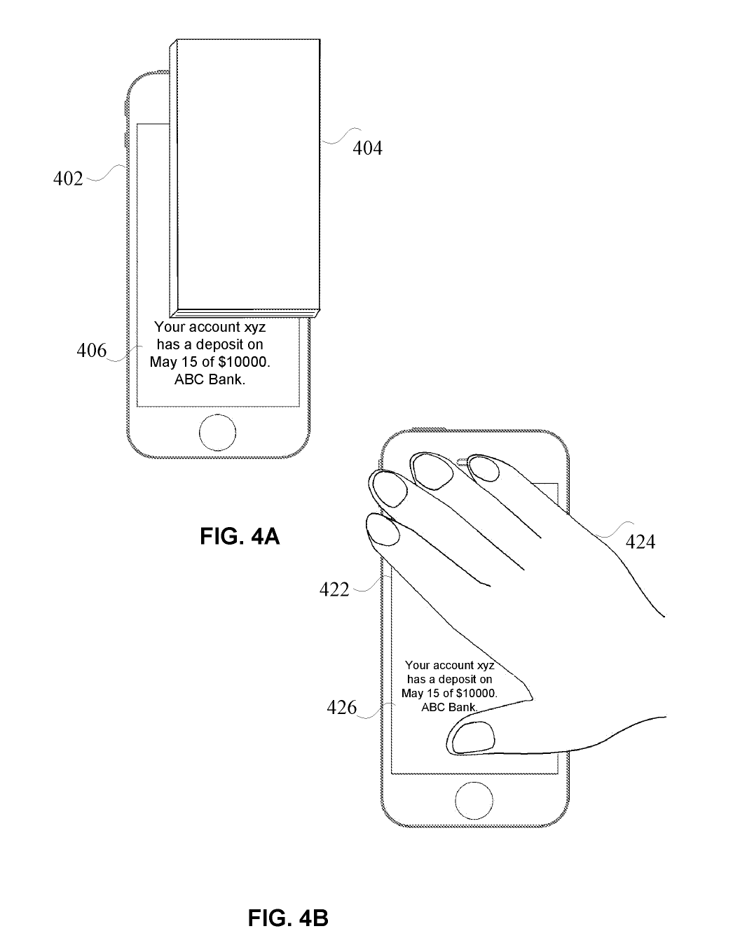

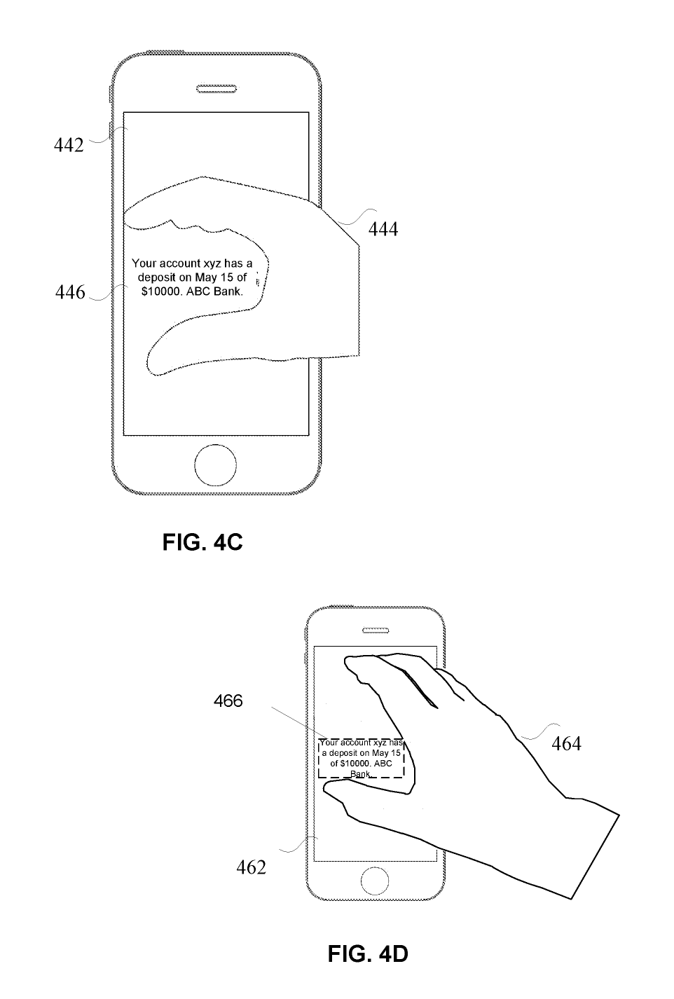

FIG. 4A illustrates a schematic diagram of an example scenario in which a book is used to obscure a portion of a display screen of a mobile phone, in accordance with an embodiment of the present disclosure. In this example, display screen 402 of a mobile device is implemented as a resistive touch screen. As shown herein, a book 404 is placed above display screen 402, covering the upper right portion of display screen 402. As a result, display screen 402 is configured to detect there is a change in impedance at the upper right portion due to the contact exerted by book 404. Therefore, display screen 402 is configured to determine the un-obscured portion (e.g., the lower left portion) of display screen 402 as first region 406 of display screen 402. As shown herein, the content of an incoming message is displayed in first region 406 accordingly.

FIG. 4B illustrates a schematic diagram of another example scenario in which a user's hand is used to obscure a portion of a display screen of a mobile phone, in accordance with an embodiment of the present disclosure. In this example, display screen 422 of a mobile device is implemented as a capacitive touch screen. As shown herein, a hand 424 is placed above display screen 422, covering the upper right portion of display screen 422. As a result, display screen 422 is configured to detect there is a change in capacitance in the upper right portion due to the charges drawn by hand 424. Therefore, display screen 422 is configured to determine the un-obscured portion (e.g., the lower left portion) of display screen 422 as first region 426 of display screen 422. As shown herein, the content of an incoming message is displayed in first region 426 accordingly.

FIG. 4C illustrates a schematic diagram of yet another example scenario in which a user's hand gesture (e.g., shape of user's hand gesture) is used to determine a first region of a display screen of a mobile phone, in accordance with an embodiment of the present disclosure. In this example, display screen 442 of a mobile device is implemented as an infrared screen. Infrared light beams are transmitted both horizontally and vertically over display screen 442. Upon a touch or contact with display screen 442, the light beams are interrupted, based on which obscured regions and un-obscured regions can be determined. For example, the areas detecting interruptions with light beams are obscured regions, while those not detecting such interruptions are un-obscured regions.

As shown herein, in this embodiment, the user's hand is gestured in a form that the fingers are held substantially together into a curling, sometimes tilting wall above display screen 442. Consequently, the area that is partially enclosed by the hand gesture 444 is determined as a first region 446 of display screen 442 for displaying data. Upon the arrival of an SMS message, display screen 442 is configured to detect the shape of the hand gesture, and a specific area relative to the detected hand gesture region is selected to be the unobscured display area. For example, the display screen is configured to detect that the user has hand gestured a partially enclosing wall (cup)), and the center region of the cup is the unobscured area. As a result, display screen 442 is configured to determine that the first region (target region) for displaying the received SMS message is the area that is partially enclosed by the user's hand gesture, and subsequently to display the SMS message in the determined first region such that enhanced privacy is provided to the user. In this case, the first region is shown as the area at the inner side of the user's curling fingers and along the edge of the user's palm towards display screen 442.

In some embodiments, the user is able to adjust the hand gesture, e.g., adjust the position at which the hand is gestured on display screen 442. Accordingly, display screen 442 is configured to detect the changes in the user's hand gesture in real time, and updates the definition of the first region based on the newly detected user hand gesture in real time. For example, the user may start by placing his or her hand as gestured in FIG. 4C to view the SMS message in a first region located towards the left bottom portion of display screen 442. Viewing a long text message, the user may move the gesturing hand upward a little such that the first region is determined as a relatively larger area to display the entire content of the SMS message without the user having to scroll in the first region.

In some embodiments, a display screen is configured to detect a touch event at the touch screen implemented as, for example, a resistive touch screen, a capacitive touch screen, an infrared touch screen, and the like. Based on the detected at least a point of contact and its position relative to the display screen, a user's hand gesture can be determined. Further, since the placing of a user's hand over the display screen blocks an amount of ambient light sensed on the display screen, the first region can be determined based on the above-described hand gesture and the change incurred by the hand gesture in the brightness level and/or intensity level of the ambient light sensed at the display screen. In general, in order to provide heightened privacy guards while the sensitive or personal data is displayed, such data is displayed in the portion of the display screen where the sensed ambient light is of less brightness or intensity. Taking the hand gesture illustrated in FIG. 4C for example, hand gesture 444 is formed by a user's fingers held substantially together and curling inward into a curved palm wall (palm cup) over display screen 442. As such, the area to the left side (inside) of the hand is partially enclosed by the hand wall and therefore senses ambient light at a less brightness level and/or intensity level. Thus, the first region is the portion that is located inside and partially enclosed by the hand wall.

FIG. 4D illustrates a schematic diagram of still yet another example scenario in which a user's hand is used to provide further privacy guards for a target region of a display screen of a mobile phone, in accordance with an embodiment of the present disclosure. In this example, the user draws an area by use of a finger, a stylus, or the like, to designate the area of display screen 462 as a target region 466 for displaying sensitive or personal data. Subsequently, the user may further render the target region of the display screen obscured by an object 464 such as a hand, a book, a purse, a hand gesture etc. such that the data displayed in the target region is further protected from being viewed by other people nearby. Here, as target region 466 is already determined, it is no longer necessary for the obscuring object or hand gesture to contact the display screen, as the main purpose of the object or hand gesture here is to provide further privacy to the user who is viewing sensitive or personal data in target region 466. Nevertheless, when the obscuring object or hand gesture is placed to obscure an area other than or partially overlapping with the target region, the display screen can be configured to determine a first region that modifies the target region such that the user can update the definition (e.g., location) of the target region for displaying data. In some embodiments, when a user's hand gestures along the display screen, the position of the first region is updated in real time to capture the intended portion on the display screen for displaying data. Furthermore, in addition to the location of the first region, other parameters defining a first region such as the shape, the size, the brightness level, the opacity level, and the like can also be updated in real time when a user's hand gesture moves about the display screen.

In some embodiments, after the data is displayed in the first region, if the display screen ceases to detect that a portion thereof is being obscured, the displayed data is no longer rendered in the first region. In particular, first, the user designates a first region by using a hand gesture to obscure a portion of the display screen. Then, data (e.g., SMS messages) is displayed in the first region accordingly afterwards. After checking the message, the user moves the hand gesture away from the display screen such that none of the display screen is obscured. Consequently, the displayed message disappears from the first region. As such, the automatic disappearing of data displayed in the first region upon detecting the display screen is no longer obscured, on the one hand, provides a user-friendly and efficient way to exit the viewing of data. On the other hand, it ensures that no data is displayed upon the user accidentally moving the hand away from the display screen while the data is being displayed in the first region.

In some other embodiments, when the display screen no longer detects that a portion thereof is being obscured, the data being displayed in the first region is being displayed in a region other than the first region. For example, when the user moves the hand gesture away from the display screen while data is being displayed in the first region, the data is displayed in a default location on the display screen. For example, the data can be displayed at the notification bar or at a user interface of a corresponding APP. In some embodiments, the displaying region can be determined based on the user's context. For example, when the mobile device detects that the user is back at home from a mall by using, for example, a GPS sensor, upon receiving a new message, the mobile device is configured to display the message in the SMS APP. For another example, when the mobile device detects that the user is back to home from a mall, but there is a party going on at home according to the user's calendar, upon receiving a new message, the mobile device is configured to display the message in a scroll display.

FIG. 5 illustrates a schematic diagram of an example system for displaying data in accordance with an embodiment of the present disclosure. In this example, system 500 includes an identifying module 501, and a displaying module 503. Most of the functionalities performed by identifying module 501 and displaying module 503 are similar to those above-described with references to FIGS. 2-4. Therefore, for simplicity of illustration, details of these functionalities are not repeated herein.

Identifying module 501 is configured to identify data to be displayed.

Displaying module 503 is configured to display data to be displayed in a first region of a display screen, where the first region is determined based at least in part on a portion of the display screen that is being obscured. In some embodiments, the first region corresponds to the portion of the display screen that is not being obscured.

FIG. 6 illustrates a flow chart of an example process for displaying data in accordance with an embodiment of the present disclosure. Process 600 can be implemented by, for example, system 700 of FIG. 7, and/or system 800 of FIG. 8.

Process 600 starts at 602, where it is detected whether a portion of a display screen is being obscured.

At 604, in response to the portion of the display being obscured, data to be displayed is displayed in a first region of the display screen, where the first region is determined based at least in part on the portion of the display screen being obscured. In some embodiments, the first region corresponds to the portion of the display screen that is not being obscured.

FIG. 7 illustrates a schematic diagram of an example system for displaying data in accordance with an embodiment of the present disclosure. In this example, system 700 includes a detecting module 701 and an executing module 703. Most of the functionalities performed by detecting module 701 and executing module 703 are similar to those above-described with references to FIGS. 2-4. Therefore, for simplicity of illustration, details of these functionalities are not repeated herein.

Detecting module 701 is configured to detect whether a portion of a display screen is being obscured.

Executing module 703 is configured to display, in response to the portion of the display being obscured, data to be displayed in a first region of the display screen, where the first region is determined based at least in part on the portion of the display screen being obscured. In some embodiments, the first region corresponds to the portion of the display screen that is not being obscured.

The modules described above can be implemented as software components executing on one or more processors, as hardware components such as programmable logic devices (e.g., microprocessors, field-programmable gate arrays (FPGAs), digital signal processors (DSPs), etc.), Application Specific Integrated Circuits (ASICs) designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present application. The modules may be implemented on a single device or distributed across multiple devices. The functions of the modules may be merged into one another or further split into multiple submodules.

FIG. 8 is a functional diagram illustrating an embodiment of a programmed computer system for displaying data. As will be apparent, other computer system architectures and configurations can be used to display data. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In some embodiments, processor 802 includes and/or is used to provide the launch of a client application based on a message.

Processor 802 is coupled bi-directionally with memory 810, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data, and objects used by the processor 802 to perform its functions (e.g., programmed instructions). For example, memory 810 can include any suitable computer readable storage media, described below, depending on whether, for example, data access needs to be bi-directional or uni-directional. For example, processor 802 can also directly and very rapidly retrieve and store frequently needed data in a cache memory (not shown).

A removable mass storage device 812 provides additional data storage capacity for the computer system 800 and is coupled either bi-directionally (read/write) or uni-directionally (read only) to processor 802. For example, storage 812 can also include computer readable media such as magnetic tape, flash memory, PC-CARDS, portable mass storage devices, holographic storage devices, and other storage devices. A fixed mass storage 820 can also, for example, provide additional data storage capacity. The most common example of fixed mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers. Persons skilled in the art may clearly understand that, for the sake of descriptive convenience and streamlining, one may refer to the processes in the aforesaid method embodiments that correspond to specific work processes of the systems, devices, and units described above. They will not be discussed further here.

For a touch-sensitive display (also called “touch screen” or “touch display screen”), the display can include a graphical user interface (GUI). The user may interact with the GUI display via various operations such as touching with a finger, touching with a hand, and/or a gesture. Via the human-computer interactions, various functionalities can be achieved including: creating a web page, drawing, text processing, editing an electronic document, playing games, video conferencing, messaging, sending/receiving emails, making phone calls, playing video, playing audio, on-line browsing, and the like.

In one typical configuration, the computation equipment comprises one or more processors (CPUs), input/output interfaces, network interfaces, and memory.

Memory may include such forms as volatile storage devices in computer-readable media, random access memory (RAM), and/or non-volatile memory, such as read-only memory (ROM) or flash memory (flash RAM). Memory is an example of a computer-readable medium.

Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digit multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include temporary computer-readable media, (transitory media), such as modulated data signals and carrier waves.

A person skilled in the art should understand that embodiments of the present application can be provided as methods, systems, or computer program products. Therefore, the present application can take the form of an entirely hardware embodiment, an entirely software embodiment, or an embodiment that combines software and hardware aspects. In addition, the present application can take the form of computer program products implemented on one or more computer-operable storage media (including but not limited to magnetic disk storage devices, CD-ROMs, and optical storage devices) containing computer operable program codes.

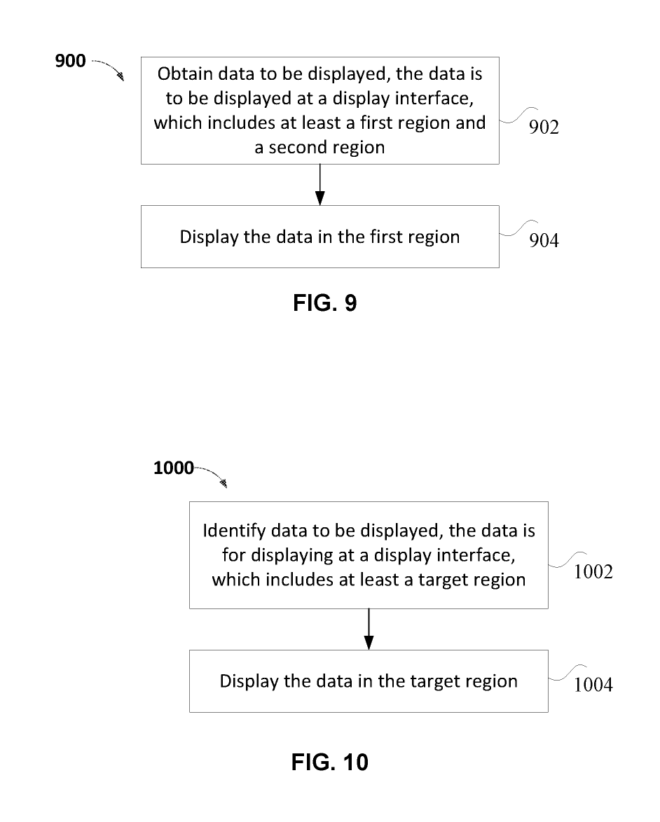

FIG. 9 illustrates a flow chart of an example process for displaying data in accordance with an embodiment of the present disclosure. Process 900 can be implemented by, for example, system 800 of FIG. 8.

Process 900 starts at 902, where data to be displayed is identified. Such data is to be displayed at a display interface, which includes at least a first region and a second region. In some embodiments, the first region corresponds to a portion that is not being obscured; and the second region corresponds to a portion that is not being obscured.

At 904, data to be displayed is displayed at the first region.

In some embodiments, the data to be displayed is the data such as text, pictures, videos, animations, or alike digital content for display on a computer device including, for example, a mobile phone, a tablet computer, a notebook computer, a wearable device, an IoT device, an in-vehicle device, a MID device, a computer, or the like. The display interface can include an interface rendered on the display screen of the device, or the UI of the device, or an interface of an application. The display interface is partitioned into an obscured region and an un-obscured region. Upon identifying sensitive or personal data for displaying, such data is displayed in the obscured region. For example, during the process of providing a merchant with the proof of payment, the user can have the information such as the payment account number displayed in the obscured region such that enhanced privacy and security can be applied to the process conducted on the mobile device.

The determination of obscured and un-obscured regions is substantially similar to those described above (by use of detecting changes in surface pressure and/or the brightness level or intensity level of ambient light detected at the display screen) with reference to FIGS. 2-4. Therefore, the details are not repeated herein.

FIG. 10 illustrates a flow chart of another example process for displaying data in accordance with an embodiment of the present disclosure. Process 1000 can be implemented by, for example, system 800 of FIG. 8.

Process 1000 starts at 1002, where data to be displayed is identified. Such data is to be displayed at a display interface, which includes at least a target region. Depending on how a portion of the display screen is obscured, in some embodiments, the target region corresponds to a portion that is not being obscured; and in some other embodiments, the target region corresponds to a portion that is not being obscured.

At 1004, data to be displayed is displayed at the target region. In some embodiments, the target region can be implemented as first region 406 of FIG. 4A, and/or first region 426 of FIG. 4B, which are both un-obscured regions of the display screen. In some other embodiments, the target region can be implemented as first region 446 of FIG. 4C, and/or target region 466 of FIG. 4D, which are both obscured regions of the display screen.

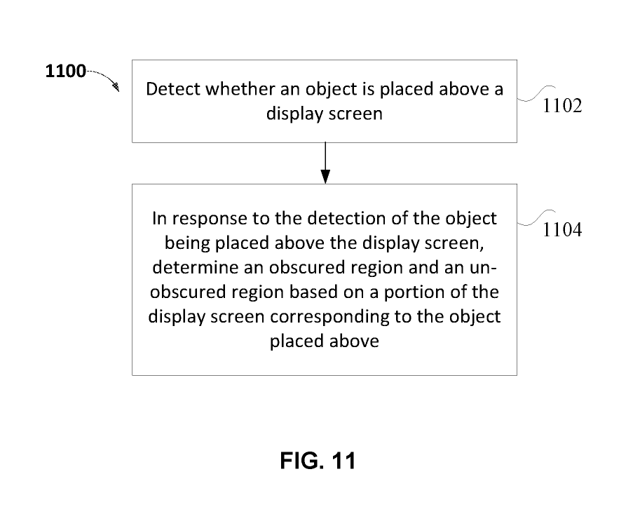

FIG. 11 illustrates a flow chart of yet another example process for displaying data in accordance with an embodiment of the present disclosure. Process 1100 can be implemented by, for example, system 800 of FIG. 8.

Process 1100 starts at 1102, where it is detected whether an object is placed above a display screen, which is configured to display a display interface.

At 1104, in response to the detection that an object is placed above the display screen, determine an obscured region and an un-obscured region based on a portion corresponding to the object placed above. In some embodiments, the object placed above the display screen blocks ambient light sensed at the display screen and projects a shadow on the display screen, based on which the obscured region and the un-obscured region can be determined. For example, a portion of the display screen that senses less brightness level or intensity level of ambient light, or a shadow on the surface can be determined as the obscured region. On the other hand, a portion of the display screen that does not senses a change in the brightness level or intensity level of ambient light, or a showdown on the surface can be determined as the un-obscured region.

According to various embodiments of the present disclosure, a system for displaying data comprises one or more processors configured identify data to be displayed; and to display the data in a first region of a display screen, where the first region is determined based at least in part on a portion of the display screen that is being obscured. The system for display data further comprises and one or more memories coupled to the one or more processors, configured to provide the one or more processors with instructions.

According to various embodiments of the present disclosure, a system for displaying data comprises one or more processors configured to detect that a portion of a display screen is being obscured; and to display, in response to the detection that the portion of the display is being obscured, data to be displayed in a first region of the display screen, where the first region is determined based at least in part on the portion of the display screen being obscured. The system for display data further comprises one or more memories coupled to the one or more processors, configured to provide the one or more processors with instructions.

According to various embodiments of the present disclosure, a process for displaying data comprises detecting that a portion of a display screen is being obscured; and displaying, in response to the portion of the display being obscured, data to be displayed in a first region of the display screen, where the first region is determined based at least in part on the portion of the display screen being obscured.

According to some embodiments of the present disclosure, a process for displaying data further comprises detecting that an object is positioned above the display screen; determining, in response to detecting that the object is positioned above the display screen, that the portion of the display screen is being obscured; and retrieving, in response to the detection that the object is positioned above the display screen, the data to be displayed.

According to various embodiments of the present disclosure, a computer program product, that is embodied in a tangible computer readable storage medium, comprises computer instructions for: detecting whether a portion of a display screen senses is being obscured; and displaying, in response to the portion of the display being obscured, data to be displayed in a first region of the display screen, where the first region is determined based at least in part on the portion of the display screen being obscured.

According to various embodiments of the present disclosure, a computer program product, that is embodied in a tangible computer readable storage medium, comprises computer instructions for: identifying data to be displayed, wherein the data to be displayed is to be displayed at a display interface the displaying interface including a target region; and displaying the data in the target region.

The above are merely preferred embodiments of the present invention. Please note that persons with ordinary skill in the art could also make certain improvements and embellishments and that these improvements and embellishments should also be regarded as being within the protective scope of the present invention, so long as they do not depart from the principles of the present invention.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for displaying data, comprising:
identifying the data to be displayed; and
displaying the data in a first region of a display screen, wherein the first region is determined based at least in part on a portion of the display screen that is being obscured.

2. The method of claim 1, wherein the first region is determined as a portion of the display screen that is not being obscured.

3. The method of claim 1, wherein the first region is determined as a portion of the display screen that senses a change in a brightness level of ambient light due to the portion of the display screen is being obscured.

4. The method of claim 1, further comprising:
detecting whether an object is positioned above the display screen; and
retrieving, in response to the detection that the object is positioned above the display screen, the data to be displayed.

5. The method of claim 4, wherein the object is a user's hand, and wherein the first region is determined based at least in part on a user's hand gesture, the user's hand gesture obscuring the portion of the display screen.

6. The method of claim 4, further comprising:
updating, in response to a movement of the object at the display screen, a position of the first region at the display screen.

7. The method of claim 4, wherein, in response to the detection that the object is no longer positioned above the display screen, removing the displayed data from the first region of the display screen.

8. The method of claim 4, wherein, in response to the detection that the object is no longer positioned above the display screen, removing the displayed data from the first region and to be displayed in a region other than the first region.

9. The method of claim 1, wherein the portion of the display screen that is being obscured is determined based at least in part on:
determining a region having a change in impedance as the portion of the display screen that is being obscured, wherein the display screen includes a resistive panel; or
determining a region having a change in capacitance as the portion of the display screen that is being obscured, wherein the display screen includes a capacitive panel; or
determining a region having a change in acoustic energy as the portion of the display screen that is being obscured, wherein the display screen includes an acoustic sound wave panel; or
determining a region having an interruption in light emanating from the display screen as the portion of the display screen that is being obscured, wherein the display screen includes an infrared panel.

10. A method for displaying data, comprising:
identifying the data to be displayed, wherein the data to be displayed is to be displayed at a display interface, the display interface including a target region; and
displaying the data in the target region.

11. The method of claim 10, subsequent to the identifying of the data to be displayed, further comprising:
detecting whether an object is positioned above a display screen, the display screen being configured to display the display interface; and
determining, in response to the detection that the object is positioned above the display screen, an obscured region and an un-obscured region of the display interface.

12. The method of claim 10, wherein the target region is determined based at least in part on a user input that indicates an area on the display interface.

13. The method of claim 11, wherein the target region is updated based at least in part on the determined obscured region and/or the un-obscured region.

14. The method of claim 11, wherein the target region is updated as a portion of the display screen that is a part of the un-obscured region.

15. The method of claim 11, wherein the target region is updated as a portion of the display screen that senses a change in a brightness level of ambient light due to the object positioned above the display screen.

16. The method of claim 11, wherein, in response to the detection that the object is no longer positioned above the display screen, removing the displayed data from the target region of the display screen.

17. The method of claim 11, wherein, in response to the detection that the object is no longer positioned above the display screen, removing the displayed data from the target region and to be displayed in a region other than the target region.

18. The method of claim 11, wherein the determining of, in response to the detection that the object is positioned above the display screen, the obscured region and the un-obscured region of the display interface comprises:
determining a region having a change in impedance as the obscured region, wherein the display screen includes a resistive panel; or
determining a region having a change in capacitance as the obscured region, wherein the display screen includes a capacitive panel; or
determining a region having a change in acoustic energy as the obscured region, wherein the display screen includes an acoustic sound wave panel; or
determining a region having an interruption in light emanating from the display screen as the obscured region, wherein the display screen includes an infrared panel.

19. The method of claim 11, wherein the determining of, in response to the detection that the object is positioned above the display screen, the obscured region and the un-obscured region of the display interface comprises:
determining a region not having a change in impedance as the un-obscured region, wherein the display screen includes a resistive panel; or
determining a region not having a change in capacitance as the un-obscured region, wherein the display screen includes a capacitive panel; or
determining a region not having a change in acoustic energy as the un-obscured region, wherein the display screen includes an acoustic sound wave panel; or
determining a region not having an interruption in light emanating from the display screen as the un-obscured region, wherein the display screen includes an infrared panel.

20. A computer program product, the computer program product being embodied in a tangible computer readable storage medium and comprising computer instructions for:
identifying data to be displayed; and
displaying the data in a first region of a display screen, wherein the first region is determined based at least in part on a portion of the display screen that is being obscured.
